(19) United States
(12) Patent Application Publication
(10) Pub. No.: US 2022/0300801 A1
(43) Pub. Date: Sep. 22, 2022

(54) TECHNIQUES FOR ADAPTIVE GENERATION AND VISUALIZATION OF QUANTIZED NEURAL NETWORKS

(71) Applicant: VIANAI SYSTEMS, INC., Palo Alto, CA (US)

(72) Inventors: Vishal Inder SIKKA, Los Altos Hills, CA (US); Kevin Frederick DUNNELL, Waltham, MA (US); Srikar SRINATH, Palo Alto, CA (US)

(21) Appl. No.: 17/207,370

(22) Filed: Mar. 19, 2021

(51) Int. Cl. G06N 3/08; G06N 3/04

(52) U.S. Cl. CPC G06N 3/08; G06N 3/04

(57) ABSTRACT

Various embodiments set forth systems and techniques for adaptive visualization of a quantized neural network. The techniques include generating one or more network visualizations of a neural network; determining, based on the one or more network visualizations, one or more quantization schemes associated with the neural network; and re-training the neural network or approximating the neural network, based on adjusting one or more quantization coefficients associated with the one or more quantization schemes.

### BACKGROUND

### Field of the Various Embodiments

The various embodiments relate generally to computer science and neural networks and, more specifically, to techniques for adaptive generation and visualization of quantized neural networks.

### Description of the Related Art

Non-quantized neural networks are the default neural networks used in many applications. Non-quantized neural networks use floating point numbers to represent inputs, weights, activations, or the like in order to achieve high accuracy in the resulting computations. As such, non-quantized neural networks require extensive power consumption, computation capabilities (e.g., storage, working memory, cache, processor speed, or the like), network bandwidth (e.g., for transferring model to device, updating model), or the like. These requirements limit the ability to use such networks in applications implemented on devices with limited memory, power consumption, network bandwidth, computational capabilities, or the like.

Quantized neural networks have been developed to adapt the application of neural networks to a wider range of devices, hardware platforms, or the like. Quantized neural networks typically use lower precision numbers (e.g., integers) when performing computations, thereby requiring less power consumption, computation capabilities, network bandwidth, or the like. In addition, quantized neural networks are able to achieve increased computation speeds relative to non-quantized neural networks.

However, many hurdles prevent quantized neural networks from achieving accuracy that is within a reasonable range of non-quantized neural networks. One such hurdle relates to determining what quantization scheme to apply to the neural network and the inputs. While attempts have been made to address this issue, general techniques for quantizing neural networks do not account for differences in characteristics of the neural network inputs (e.g., distributions, ranges, or the like). Quantized neural networks generated using such techniques typically perform poorly relative to non-quantized neural networks.

When quantized neural networks perform poorly, users of the quantized neural network typically have no way to visualize and test the quantized neural networks in order to intuitively identify gaps in performance, deficiencies associated with training data, or the like. Further, due to the “black box” nature of typical quantized neural networks, users have no way of developing an intuitive understanding of the decisions and rationale applied by the quantized neural network in order to allow for better interpretation of the performance of the quantized neural network and to aid in testing, modifying, fine-tuning, or the like.

Accordingly, there is need for techniques for adaptive generation of quantized neural networks and for visualizing and testing the performance of quantized neural networks.

### SUMMARY

One embodiment of the present invention sets forth a computer-implemented method for adaptive visualization of a quantized neural network, the method comprising generating one or more network visualizations of a neural network; determining, based on the one or more network visualizations, one or more quantization schemes associated with the neural network; and re-training the neural network or approximating the neural network, based on adjusting one or more quantization coefficients associated with the one or more quantization schemes.

Other embodiments include, without limitation, a computer system that performs one or more aspects of the disclosed techniques, as well as one or more non-transitory computer-readable storage media including instructions for performing one or more aspects of the disclosed techniques.

The disclosed techniques achieve various advantages over prior-art techniques. In particular, by adapting the quantization scheme used to generate quantized inputs, disclosed techniques allow for generation of smaller, faster, more robust, and more generalizable quantized neural networks that can be applied to a wider range of applications. In addition, disclosed techniques provide users with a way to visualize the performance of quantized neural networks relative to non-quantized neural networks, thereby allowing users to develop an intuitive understanding of the decisions and rationale applied by the neural network quantization scheme and process and to better interpret changes in factors that correlate with the performance of the quantized neural network (e.g., changes in patterns of connections between neurons, areas of interest, weights, activations, or the like). As such, users are able to determine what parameters to adjust in order to fine-tune and improve the performance of the quantized neural network.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating a computing system configured to implement one or more aspects of the present disclosure.

FIG. 2 is a more detailed illustration of the quantization engine of FIG. 1, according to various embodiments of the present disclosure.

FIG. 3 is a more detailed illustration of the visualization engine of FIG. 1, according to various embodiments of the present disclosure.

FIG. 4 is a flowchart of method steps for a network quantization procedure performed by the quantization engine of FIG. 1, according to various embodiments of the present disclosure.

FIG. 5 is a flowchart of method steps for a network visualization procedure performed by the visualization engine of FIG. 1, according to various embodiments of the present disclosure.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

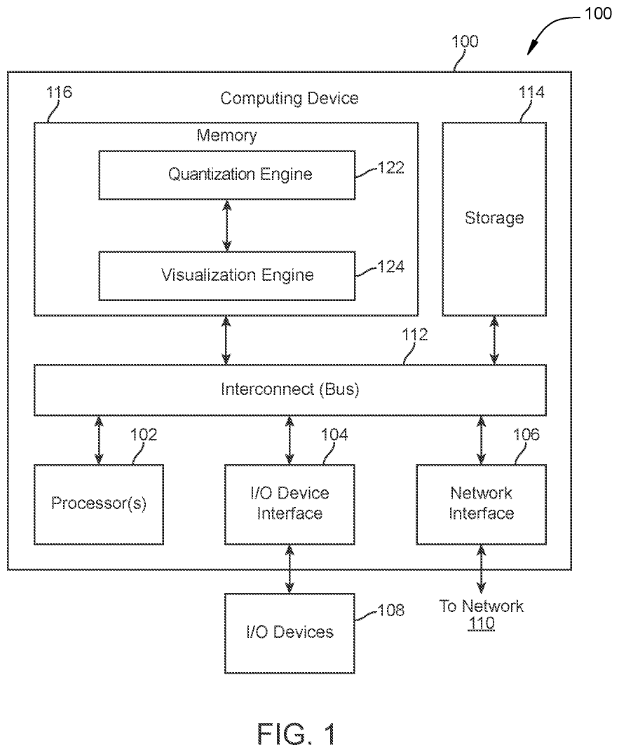

FIG. 1 illustrates a computing device 100 configured to implement one or more aspects of the present disclosure. As shown, computing device 100 includes an interconnect (bus) 112 that connects one or more processor(s) 102, an input/output (I/O) device interface 104 coupled to one or more input/output (I/O) devices 108, memory 116, a storage 114, and a network interface 106.

Computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and that any other technically feasible configurations fall within the scope of the present disclosure.

Processor(s) 102 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O device interface 104 enables communication of I/O devices 108 with processor(s) 102. I/O device interface 104 generally includes the requisite logic for interpreting addresses corresponding to I/O devices 108 that are generated by processor(s) 102. I/O device interface 104 may also be configured to implement handshaking between processor(s) 102 and I/O devices 108, and/or generate interrupts associated with I/O devices 108. I/O device interface 104 may be implemented as any technically feasible CPU, ASIC, FPGA, any other type of processing unit or device.

I/O devices 108 include devices capable of providing input, such as a keyboard, a mouse, a touch-sensitive screen, a microphone, a remote control, a camera, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user of computing device 100, and to also provide various types of output to the end-user of computing device 100, such as displayed digital images or digital videos or text. In some embodiments, one or more of I/O devices 108 are configured to couple computing device 100 to a network 110.

In some embodiments, I/O devices 108 can include, without limitation, a smart device such as a personal computer, personal digital assistant, tablet computer, mobile phone, smart phone, media player, mobile device, or any other device suitable for implementing one or more aspects of the present invention. I/O devices 108 can augment the functionality of computing device 100 by providing various services, including, without limitation, telephone services, navigation services, infotainment services, or the like. Further, I/O devices 108 can acquire data from sensors and transmit the data to computing device 100. I/O devices 108 can acquire sound data via an audio input device and transmit the sound data to computing device 100 for processing. Likewise, I/O devices 108 can receive sound data from computing device 100 and transmit the sound data to an audio output device so that the user can hear audio originating from computing device 100. In some embodiments, I/O devices 108 include sensors configured to acquire biometric data from the user (e.g., heart rate, skin conductance, or the like) and transmit signals associated with the biometric data to computing device 100. The biometric data acquired by the sensors can then be processed by a software application running on computing device 100. In various embodiments, I/O devices 108 include any type of image sensor, electrical sensor, biometric sensor, or the like, that is capable of acquiring biometric data including, for example and without limitation, a camera, an electrode, a microphone, or the like. In some embodiments, I/O devices 108 can receive structured data (e.g., tables, structured text), unstructured data (e.g., unstructured text), images, video, or the like.

In some embodiments, I/O devices 108 include, without limitation, input devices, output devices, and devices capable of both receiving input data and generating output data. I/O devices 108 can include, without limitation, wired or wireless communication devices that send data to or receive data from smart devices, headphones, smart speakers, sensors, remote databases, other computing devices, or the like. Additionally, in some embodiments, I/O devices 108 may include a push-to-talk (PTT) button, such as a PTT button included in a vehicle, on a mobile device, on a smart speaker, or the like. In some embodiments, I/O devices 108 may be configured to handle voice triggers or the like.

Network 110 includes any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

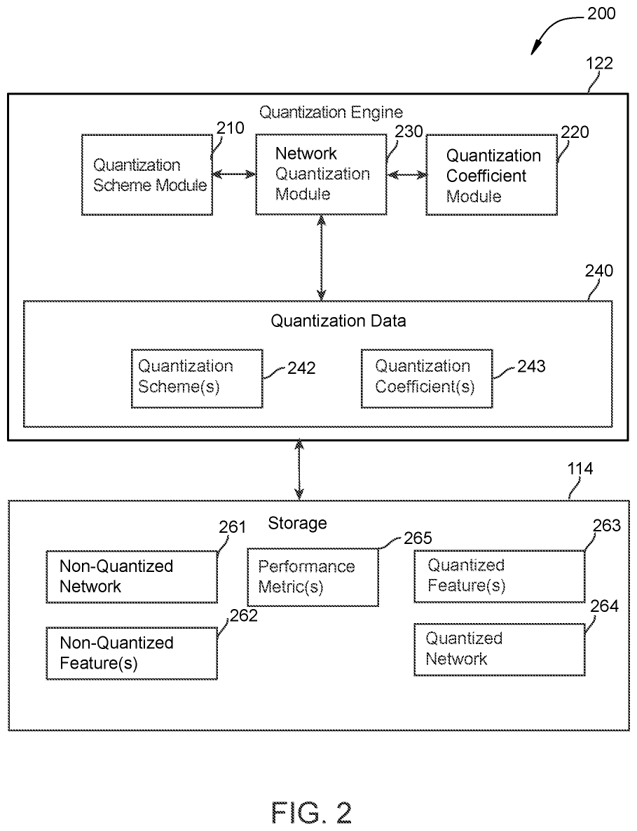

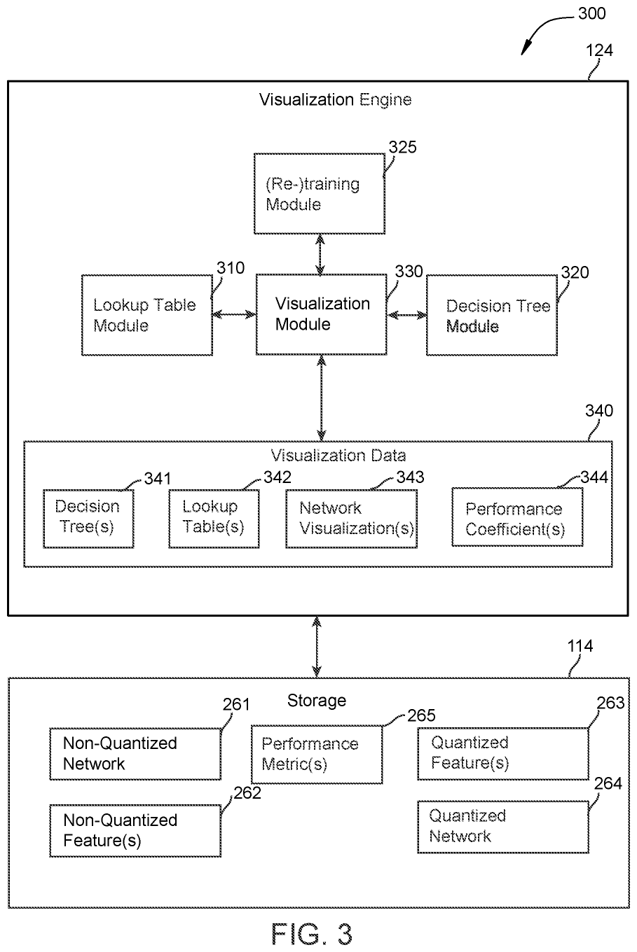

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including quantization engine 122 and visualization engine 124. Quantization engine 122 and visualization engine 124 are described in further detail below with respect to FIG. 2 and FIG. 3, respectively.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Quantization engine 122 and visualization engine 124 may be stored in storage 114 and loaded into memory 116 when executed.

FIG. 2 is a more detailed illustration 200 of quantization engine 122 and storage 114 of FIG. 1, according to various embodiments of the present disclosure. As shown, storage 114 includes, without limitation, non-quantized network 261, non-quantized feature(s) 262, quantized feature(s) 263, quantized network 264, and/or performance metric(s) 265. Quantization engine 122 includes, without limitation, quantization scheme module 210, quantization coefficient module 220, network quantization module 230, and/or quantization data 240.

Non-quantized network 261 includes any technically feasible machine learning model. In some embodiments, non-quantized network 261 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, non-quantized network 261 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), Transformers, BERT-based (Bidirectional Encoder Representations from Transformers) models, and/or other types of artificial neural networks or components of artificial neural networks. In other embodiments, non-quantized network 261 includes functionality to perform clustering, principal component analysis (PCA), latent semantic analysis (LSA), Word2vec, or the like. In some embodiments, non-quantized network 261 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like. In some embodiments, non-quantized network 261 includes a multi-layer perceptron or the like.

Non-quantized feature(s) 262 include one or more inputs associated with one or more input nodes of non-quantized network 261. In some embodiments, the one or more inputs include one or more floating point values in one or more high bit-depth representation (e.g., 32-bit floating point value or the like). In some embodiments, the one or more inputs derived from one or more datasets (e.g., images, text, or the like). In some embodiments, the one or more inputs includes any type of data such as nominal data, ordinal data, discrete data, continuous data, or the like.

Quantized feature(s) 263 include one or more inputs associated with one or more input nodes of quantized network 264. In some embodiments, the one or more inputs derived from one or more datasets (e.g., images, text, or the like). In some embodiments, the one or more inputs includes any type of data such as nominal data, ordinal data, discrete data, continuous data, or the like. In some embodiments, quantized features 263 include one or more values associated with mapping non-quantized features 262 to a lower-precision representation or the like. In some embodiments, the lower-precision representation includes one or more lower-precision numerical formats (e.g., integers), a lower bit-depth representation (e.g., 16-bit integer, 8-bit integer, 4-bit integer, 1-bit integer), or the like.

Quantized network 264 includes any technically feasible machine learning model generated by applying one or more quantization techniques to non-quantized networks 261. In some embodiments, quantized network 264 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, quantized network 264 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), Transformers, BERT-based (Bidirectional Encoder Representations from Transformers) models, and/or other types of artificial neural networks or components of artificial neural networks. In other embodiments, quantized network 264 includes functionality to perform clustering, principal component analysis (PCA), latent semantic analysis (LSA), Word2vec, or the like. In some embodiments, quantized network 264 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like.

Performance metric(s) 265 include one or more metrics associated with one or more measures of the performance of quantized network 264. In some embodiments, the performance of quantized network 264 is measured relative to the performance of a baseline network, such as non-quantized network 261 or the like. In some embodiments, performance metric(s) 265 include one or more measures of network accuracy (e.g., classification accuracy, detection accuracy, estimation accuracy for regressions, error calculation, root mean squared error (RMSE)), computational efficiency (e.g., inference speed, training speed, run-time memory usage, run-time power consumption, run-time network bandwidth, or the like), quantization error (e.g., difference between one or more non-quantized features 262 and one or more quantized features 263), or the like.

In some embodiments, performance metric(s) 265 include any metric used for evaluating a neural network such as mean average precision (e.g., based on positive prediction value), mean average recall (e.g., based on true positive rate), mean absolute error (MAE), root mean squared error (RMSE), receiver operating characteristics (ROC), F1-score (e.g., based on harmonic mean of recall and precision), area under the curve (AUC), area under the receiver operating characteristics (AUROC), mean squared error (MSE), statistical correlation, mean reciprocal rank (MRR), peak signal-to-noise ratio (PSNR), inception score, structural similarity (SSIM) index, frechet inception distance, perplexity, intersection over union (IoU), or the like.

Quantization data 240 includes, without limitation, quantization scheme(s) 242, and/or quantization coefficient(s) 243. Quantization scheme(s) 242 include any technically feasible scheme for mapping non-quantized features 262 to quantized features 263. In some embodiments, quantization scheme(s) 242 include any technically feasible scheme for mapping non-quantized network parameters, weights, biases, or the like to quantized equivalents. Quantization scheme(s) 242 include, without limitation, linear quantization schemes (e.g., dividing entire range of non-quantized features 262, quantized features 263, or the like into equal intervals), non-linear quantization schemes (e.g., having smaller or larger quantization intervals that match distribution of non-quantized features 262, distribution of quantized features 263, or the like), adaptive quantization schemes (e.g., adapting the quantization to variations in input characteristics associated with non-quantized features 262, quantized features 263, or the like), or logarithmic quantization schemes (e.g., quantizing the log-domain values associated with non-quantized features 262, quantized features 263, or the like).

Quantization coefficient(s) 243 include one or more variables associated with quantization scheme(s) 242. In some embodiments, quantization coefficient(s) 243 include offset (e.g., zero point), scale factor, conversion factor, bit width, or the like. In some embodiments, quantization coefficient(s) 243 are calculated based on one or more actual or target statistical properties (e.g., mean values, minimum or maximum values, standard deviation, range of values, median values, and/or the like) associated with non-quantized features 262, quantized features 263, or the like. In some embodiments, the one or more actual or target statistical properties are associated with the dynamic range of the features (e.g., non-quantized features 262, quantized features 263, or the like), nature of the distribution (e.g., symmetrical distribution, asymmetrical distribution, or the like), quantization precision tradeoff (e.g., threshold range that minimizes loss of information, error distribution, maximum absolute error), or the like.

In operation, quantization scheme module 210 adaptively derives one or more attributes associated with non-quantized features 262 using one or more dimension reduction techniques. Quantization scheme module 210 then selects, based on the one or more attributes, one or more quantization scheme(s) 242 for mapping one or more non-quantized features 262 to one or more quantized features 263. Quantization coefficient module 220 determines one or more quantization coefficient(s) 243 associated with the one or more quantization scheme(s) 242 selected by quantization scheme module 210. Network quantization module 230 generates quantized feature(s) 263 based on non-quantized feature(s) 262, the one or more quantization scheme(s) 242, and the quantization coefficient(s) 243. Network quantization module 230 generates quantized network 264 using one or more quantization techniques.

Quantization scheme module 210 adaptively derives one or more attributes associated with non-quantized features 262 or the like using one or more dimension reduction techniques (e.g., feature selection techniques, feature projection techniques, k-nearest neighbors algorithms, or the like). In some embodiments, the feature selection techniques include wrapper methods, filter methods, embedded methods, LASSO (least absolute shrinkage and selection operator) method, elastic net regularization, step-wise regression, or the like. In some embodiments, the feature projection techniques include principal component analysis (PCA), graph-based kernel PCA, non-negative matrix factorization (NMF), linear discriminant analysis (LDA), generalized discriminant analysis (GDA), t-distributed stochastic neighbor embedding (t-SNE), or the like. In some embodiments, quantization scheme module 210 derives the one or more attributes based on one or more evaluation metrics (e.g., target quantization precision, model error rate, mutual information, pointwise mutual information, Pearson product-moment correlation coefficient, relief-based algorithms, inter/intra class distance, regression coefficients, or the like). In some embodiments, quantization scheme module 210 determines one or more evaluation scores for each attribute subset based on the one or more evaluation metrics or the like. In some embodiments, quantization scheme module 210 determines one or more attribute or feature rankings, one or more attribute subsets, one or more redundant or irrelevant attributes, or the like based on the one or more dimension reduction techniques, the one or more evaluation metrics, or the like.

Quantization scheme module 210 selects, based on the one or more attributes, one or more quantization scheme(s) 242. Each of the one or more quantization scheme(s) 242 specifies a different mechanism for mapping one or more non-quantized features 262 to one or more quantized features 263. In some embodiments, quantization scheme module 210 selects the quantization scheme(s) 242 based on one or more feature vectors associated with non-quantized features 262 or the like. In some embodiments, quantization scheme module 210 selects the quantization scheme(s) 242 based on a subset of relevant attributes associated with non-quantized features 262 or the like. In some embodiments, quantization scheme module 210 adaptively selects the one or more quantization scheme(s) 242 based on the distribution of one or more attributes of non-quantized features 262, the distribution of one or more attributes of quantized features 263, divergence between the distribution of one or more attributes of non-quantized features 262 and the distribution of one or more attributes of quantized features 263, minimum or maximum values of non-quantized features 262, minimum or maximum values of quantized features 263, moving average of minimum or maximum values across one or more batches of non-quantized features 262, moving average of minimum or maximum values across one or more batches of quantized features 263, or the like. In some embodiments, quantization scheme module 210 adaptively selects the one or more quantization scheme(s) 242 based on any predefined relationship of training data or the like. In some embodiments, quantization scheme module 210 adaptively selects a different quantization scheme(s) 242 for each layer, for each channel, for each parameter, for each kernel, or the like of non-quantized network 261. In some embodiments, quantization scheme module 210 adaptively selects one or more quantization scheme(s) 242 based on the target characteristics of the network output (e.g., range of values, maximum value, offset, minimum value, mean values, standard deviation, or the like).

Quantization coefficient module 220 determines one or more quantization coefficient(s) 243 associated with the one or more quantization scheme(s) 242 selected by quantization scheme module 210. In some embodiments, quantization coefficient module 220 determines one or more quantization coefficient(s) 243 based on one or more evaluation metrics associated with one or more quantization scheme(s) 242 selected by quantization scheme module 210. In some embodiments, the one or more evaluation metrics include target quantization precision, model error rate, mutual information, pointwise mutual information, Pearson product-moment correlation coefficient, relief-based algorithms, inter/intra class distance, regression coefficients, or the like. In some embodiments, quantization coefficient module 220 adaptively applies a unique quantization coefficient(s) 243 to each unique attribute of non-quantized features 262 or the like.

In some embodiments, quantization coefficient module 220 determines one or more quantization coefficient(s) 243 based on one or more feature vectors associated with non-quantized features 262 or the like. In some embodiments, quantization coefficient module 220 determines one or more quantization coefficient(s) 243 based on a subset of relevant attributes, the distribution of one or more attributes of non-quantized features 262, the distribution of one or more attributes of quantized features 263, divergence between the distribution of one or more attributes of non-quantized features 262 and the distribution of one or more attributes of quantized features 263, minimum or maximum values of non-quantized features 262, minimum or maximum values of quantized features 263, moving average of minimum or maximum values across one or more batches of non-quantized features 262, moving average of minimum or maximum values across one or more batches of quantized features 263, or the like. In some embodiments, quantization coefficient module 220 determines one or more quantization coefficient(s) 243 for each layer, for each channel, for each parameter, for each kernel, or the like of non-quantized network 261. In some embodiments, quantization coefficient module 220 determines one or more quantization coefficient(s) 243 based on the target characteristics of the network output (e.g., range of values, maximum value, offset, minimum value, mean values, standard deviation, or the like).

Network quantization module 230 generates quantized feature(s) 263 based on non-quantized feature(s) 262, one or more quantization scheme(s) 242, and/or quantization coefficient(s) 243. In some embodiments, network quantization module 230 uses quantization scheme module 210 to adaptively select, for each (re-)training iteration, the one or more quantization scheme(s) 242 used to generate quantized feature(s) 263. In some embodiments, the one or more quantization scheme(s) 242 used to generate quantized feature(s) 263 can be iteratively (re-)selected based on one or more performance metric(s) 265. In some embodiments, the one or more quantization scheme(s) 242 can be iteratively (re-)selected for each layer, for each channel, for each parameter, for each kernel, or the like of non-quantized network 261, quantized network 264, or the like. In some embodiments, network quantization module 230 uses quantization coefficient module 220 to update, for each (re-)training iteration, the one or more quantization coefficient(s) 243 used to generate quantized feature(s) 263. The one or more quantization coefficient(s) 243 can be iteratively updated based on the one or more performance metric(s) 265, a loss function, or the like. In some embodiments, the one or more quantization coefficient(s) 243 can be iteratively updated for each layer, for each channel, for each parameter, for each kernel, or the like of non-quantized network 261, quantized network 264, or the like. In some embodiments, network quantization module 230 iteratively (re-)generates quantized feature(s) 263 for each (re-)training iteration based on iteratively selecting the one or more quantization scheme(s) 242, the one or more quantization coefficient(s) 243, the one or more performance metric(s) 265, or the like.

Network quantization module 230 generates quantized network 264 using one or more quantization techniques such as trained quantization, fixed quantization, soft-weight sharing, or the like. In some embodiments, network quantization module 230 generates quantized network 264 by (re-)training non-quantized network 261 using quantized features 263 or the like. In some embodiments, network quantization module 230 performs iterative quantization by (re-)training non-quantized network 261, quantized network 264, or the like using quantized features 263 until one or more performance metric(s) 265 are achieved. In some embodiments, network quantization module 230 generates quantized network 264 using supervised learning, unsupervised learning, semi-supervised learning (e.g., supervised pre-training followed by unsupervised fine-tuning, unsupervised pre-training followed by supervised fine-tuning, or the like), self-supervised learning, or the like.

In some embodiments, network quantization module 230 (re-)trains non-quantized network 261, quantized network 264, or the like using non-quantized features 262 or quantized features 263, and full precision weights, activations, biases, or the like. In some embodiments, network quantization module 230 performs iterative quantization by (re-)training non-quantized network 261, quantized network 264, or the like using a certain proportion of non-quantized features 262 and/or quantized features 263 until one or more performance metric(s) 265 are achieved. In some embodiments, network quantization module 230 (re-)trains non-quantized network 261, quantized network 264, or the like by simulating the effects of quantization during inference.

In some embodiments, network quantization module 230 updates the network parameters associated with non-quantized network 261, quantized network 264, or the like at each (re-)training iteration based on one or more performance metric(s) 265, a loss function, or the like. In some embodiments, the update is performed by propagating a loss backwards through non-quantized network 261, quantized network 264, or the like to adjust parameters of the model or weights on connections between neurons of the neural network.

In some embodiments, network quantization module 230 repeats the (re-)training process for multiple iterations until a threshold condition is achieved. In some embodiments, the threshold condition is achieved when the (re-)training process reaches convergence. For instance, convergence is reached when one or more performance metric(s) 265, a loss function, or the like changes very little or not at all with each iteration of the (re-)training process. In another instance, convergence is reached when one or more performance metric(s) 265, the loss function, or the like stays constant after a certain number of iterations or begins trending in a direction opposite from the desired direction or the like (e.g., when loss begins increasing, validation accuracy begins decreasing, or the like). In some embodiments, the threshold condition is a predetermined value or range for one or more performance metric(s) 265, the loss function, or the like. In some embodiments, the threshold condition is a certain number of iterations of the (re-)training process (e.g., 100 epochs, 600 epochs), a predetermined amount of time (e.g., 2 hours, 50 hours, 48 hours), or the like.

Network quantization module 230 (re-)trains non-quantized network 261, quantized network 264, or the like using one or more hyperparameters. Each hyperparameter defines “higher-level” properties the neural network instead of internal parameters that are updated during (re-)training and subsequently used to generate predictions, inferences, scores, and/or other output. Hyperparameters include a learning rate (e.g., a step size in gradient descent), a convergence parameter that controls the rate of convergence in a machine learning model, a model topology (e.g., the number of layers in a neural network or deep learning model), a number of training samples in training data for a machine learning model, a parameter-optimization technique (e.g., a formula and/or gradient descent technique used to update parameters of a machine learning model), a data-augmentation parameter that applies transformations to inputs, a model type (e.g., neural network, clustering technique, regression model, support vector machine, tree-based model, ensemble model, etc.), or the like.

FIG. 3 is a more detailed illustration 300 of visualization engine 124 of FIG. 1, according to various embodiments of the present disclosure. As shown, visualization engine 124 includes, without limitation, lookup table module 310, decision tree module 320, visualization module 330, and/or visualization data 340.

Visualization data 340 includes any data associated with a visual representation of non-quantized network 261, quantized network 264, or the like. In some embodiments, visualization data 340 includes one or more decision tree(s) 341, one or more lookup table(s) 342, one or more network visualization(s) 343 associated with the one or more performance metric(s) 265, one or more performance coefficient(s) 344 associated with the one or more performance metric(s) 265, or the like.

Decision tree(s) 341 include any technically feasible tree representation associated with non-quantized network 261, quantized network 264, or the like. In some embodiments, the one or more decision tree(s) 341 include any tree representation driven by one or more performance metric(s) 265 or the like. In some embodiments, the one or more network visualization(s) 343 include any tree representation of each layer, for each channel, for each parameter, for each kernel, or the like of non-quantized network 261, quantized network 264, or the like. In some embodiments, the one or more decision tree(s) 341 can be used to replace non-quantized network 261, quantized network 264, or the like during inference, prediction, or the like. In some embodiments, the one or more decision tree(s) 341 are structured, programmed, or the like to execute at run-time instead of non-quantized network 261, quantized network 264, or the like.

Lookup table(s) 342 include any technically feasible lookup-based representation (e.g., array with rows and columns) associated with non-quantized network 261, quantized network 264, or the like. In some embodiments, one or more lookup table(s) 342 replace one or more runtime functions or computations performed by non-quantized network 261, quantized network 264, or the like with one or more array indexing or input/output operations or the like. In some embodiments, one or more lookup table(s) 342 include any lookup-based representation associated with the one or more performance metric(s) 265 or the like. In some embodiments, one or more lookup table(s) 342 include any lookup-based representation of each layer, for each channel, for each parameter, for each kernel, or the like of non-quantized network 261, quantized network 264, or the like. In some embodiments, the one or more lookup table(s) 342 can be used to replace non-quantized network 261, quantized network 264, or the like during inference, prediction, or the like. In some embodiments, the one or more lookup table(s) 342 are structured, programmed, or the like to execute at run-time instead of non-quantized network 261, quantized network 264, or the like.

Network visualization(s) 343 include any visual representation associated with non-quantized network 261, quantized network 264, or the like. In some embodiments, network visualization(s) 343 include any visualization associated with the any aspect of non-quantized network 261, quantized network 264, or the like including inputs, inner layer outputs, parameters (e.g., weight and bias distributions and contributions), or the like. In some embodiments, the one or more network visualization(s) 343 include any visual representation associated with the one or more performance metric(s) 265 or the like. In some embodiments, the one or more network visualization(s) 343 include a visual representation of each layer, for each channel, for each parameter, for each kernel, or the like of non-quantized network 261, quantized network 264, or the like.

Performance coefficient(s) 344 include one or more variables associated with one or more performance metric(s) 265. In some embodiments, the one or more performance coefficient(s) 344 are calculated based on one or more actual or target statistical properties (e.g., mean values, minimum or maximum values, standard deviation, range of values, median values, and/or the like) associated with non-quantized network 261, non-quantized features 262, quantized features 263, quantized network 264, quantization data 240, or the like. In some embodiments, performance coefficient(s) 344 are calculated based on one or more quantization coefficient(s) 243. In some embodiments, performance coefficient(s) 344 include one or more binning schemes or the like.

In operation, visualization module 330 generates one or more network visualization(s) 343 associated with the changes to the one or more performance metric(s) 265 associated with non-quantized network 261, quantized network 264, or the like during (re-)training, inference, or the like. Visualization module 330 determines, based on the one or more network visualization(s) 343, one or more quantization coefficient(s) 243, one or more performance coefficient(s) 344, or the like. Visualization module 330 adjusts the one or more quantization coefficient(s) 243, the one or more performance coefficient(s) 344, or the like based on the target performance of non-quantized network 261, quantized network 264, or the like. Visualization module 330 then uses (re-)training module 325 to (re-)train non-quantized network 261, quantized network 264, or the like based on the adjusted quantization coefficients, the adjusted performance coefficients, or the like.

In some embodiments, visualization module 330 optionally uses (re-)training module 325 to create a visualization associated with the generation of quantized network 264 from non-quantized network 261 or the like based on one or more non-quantized features 262. In some embodiments, (re-)training module 325 updates the network parameters associated with non-quantized network 261, quantized network 264, or the like based on adjusting one or more performance metric(s) 265, a loss function, or the like. In some embodiments, the update is performed by propagating a loss backwards through non-quantized network 261, quantized network 264, or the like to adjust parameters of the model or weights on connections between neurons of the neural network.

Visualization module 330 generates one or more network visualization(s) 343 associated with the changes to the one or more performance metric(s) 265 associated with non-quantized network 261, quantized network 264, or the like during (re-)training, inference, or the like. In some embodiments, visualization module 330 (re-)generates one or more network visualization(s) 343 of the relative changes in the one or more performance metric(s) 265 for each layer, for each channel, for each parameter, for each kernel, or the like. In some embodiments, visualization module 330 (re-)generates, for each (re-)training iteration, one or more network visualization(s) 343 showing changes to the one or more performance metric(s) 265 (e.g., network accuracy, computational efficiency, quantization error, mean average precision, mean average recall mean absolute error (MAE), root mean squared error (RMSE), receiver operating characteristics (ROC), F1-score, area under the curve (AUC), area under the receiver operating characteristics (AUROC), mean squared error (MSE), statistical correlation, mean reciprocal rank (MRR), peak signal-to-noise ratio (PSNR), inception score, structural similarity (SSIM) index, frechet inception distance, perplexity, intersection over union (IoU), or the like).

In some embodiments, visualization module 330 (re-)generates one or more network visualization(s) 343 of the relative changes in the one or more performance metric(s) 265 when (re-)training module 325 (re-)generates quantized feature(s) 263 based on iteratively selecting the one or more quantization scheme(s) 242, the one or more quantization coefficient(s) 243, the one or more performance metric(s) 265, or the like. In some embodiments, visualization module 330 (re-)generates one or more network visualization(s) 343 of the relative changes in the one or more performance metric(s) 265 when the one or more quantization scheme(s) 242 are iteratively (re-)selected for each layer, for each channel, for each parameter, for each kernel, or the like of non-quantized network 261, quantized network 264, or the like. In some embodiments, visualization module 330 (re-)generates one or more network visualization(s) 343 of the relative changes in the one or more performance metric(s) 265 when (re-)training module 325 uses quantization coefficient module 220 to update, for each (re-)training iteration, the one or more quantization coefficient(s) 243 used to generate quantized feature(s) 263. In some embodiments, visualization module 330 (re-)generates one or more network visualization(s) 343 of the relative changes in the one or more performance metric(s) 265 when (re-)training module 325 iteratively updates the one or more quantization coefficient(s) 243 based on the one or more performance metric(s) 265, the loss function, or the like.

Visualization module 330 determines, based on the one or more network visualization(s) 343, one or more quantization coefficient(s) 243, one or more performance coefficient(s) 344, or the like associated with non-quantized network 261, quantized network 264, or the like. In some embodiments, visualization module 330 calculates one or more quantization coefficient(s) 243, one or more performance coefficient(s) 344, or the like based on one or more actual statistical properties (e.g., actual mean values, actual minimum or maximum values, actual standard deviation, actual range of values, actual median values, and/or the like) associated with the one or more performance metric(s) 265. In some embodiments, visualization module 330 determines the one or more quantization coefficient(s) 243, one or more performance coefficient(s) 344, or the like based on one or more statistical properties associated with non-quantized network 261, non-quantized features 262, quantized features 263, quantized network 264, quantization data 240, or the like. In some embodiments, visualization module 330 determines the one or more quantization coefficient(s) 243, one or more performance coefficient(s) 344, or the like based on one or more actual characteristics of the network output (e.g., range of values, maximum value, offset, minimum value, mean values, standard deviation, or the like).

Visualization module 330 adjusts the one or more quantization coefficient(s) 243, one or more performance coefficient(s) 344, or the like based on the target performance of non-quantized network 261, quantized network 264, or the like. In some embodiments, visualization module 330 adjusts one or more target statistical properties (e.g., target mean values, target minimum or maximum values, target standard deviation, target range of values, target median values, and/or the like) associated with the one or more quantization coefficient(s) 243, one or more performance coefficient(s) 344, or the like. In some embodiments, visualization module 330 adjusts the one or more quantization coefficient(s) 243, one or more performance coefficient(s) 344, or the like by changing one or more target statistical properties associated with one or more performance metric(s) 265, non-quantized network 261, non-quantized features 262, quantized features 263, quantized network 264, quantization data 240, or the like. In some embodiments, visualization module 330 adjusts the one or more quantization coefficient(s) 243, one or more performance coefficient(s) 344, or the like by changing one or more target statistical properties associated with the network output (e.g., range of values, maximum value, offset, minimum value, mean values, standard deviation, or the like).

Visualization module 330 uses (re-)training module 325 to (re-)train non-quantized network 261, quantized network 264, or the like based on the adjusted quantization coefficient(s) 243, the adjusted performance coefficient(s) 344, or the like. The (re-)training is performed in a manner similar to that disclosed above with respect to network quantization module 230. For instance, (re-)training module 325 updates the network parameters associated with non-quantized network 261, quantized network 264, or the like at each (re-)training iteration based on the adjusted quantization coefficient(s) 243, the adjusted performance coefficient(s) 344, or the like. In some embodiments, (re-)training module 325 repeats the (re-)training process for multiple iterations until a threshold condition is achieved. In some embodiment, (re-)training module 325 (re-)trains non-quantized network 261, quantized network 264, or the like using one or more hyperparameters.

Lookup table module 310 generates one or more lookup table(s) 342 associated with non-quantized network 261, quantized network 264, or the like. In some embodiments, lookup table module 310 generates one or more lookup table(s) 342 using any technically feasible lookup table generation technique or the like. In some embodiments, lookup table module 310 generates one or more lookup table(s) 342 associated with one or more predictions generated by non-quantized network 261, quantized network 264, or the like. In some embodiments, lookup table module 310 generates one or more elements associated with one or more intermediate decisions generated by non-quantized network 261, quantized network 264, or the like.

In some embodiments, lookup table module 310 (re-)generates the one or more lookup table(s) 342 based on the changes to the one or more performance metric(s) 265 associated with non-quantized network 261, quantized network 264, or the like during (re-)training, inference, or the like. In some embodiments, lookup table module 310 (re-)generates, for each (re-)training iteration, the one or more lookup table(s) 342 based on the changes to the one or more performance metric(s) 265 (e.g., network accuracy, computational efficiency, quantization error, mean average precision, mean average recall mean absolute error (MAE), root mean squared error (RMSE), receiver operating characteristics (ROC), F1-score, area under the curve (AUC), area under the receiver operating characteristics (AUROC), mean squared error (MSE), statistical correlation, mean reciprocal rank (MRR), peak signal-to-noise ratio (PSNR), inception score, structural similarity (SSIM) index, frechet inception distance, perplexity, intersection over union (IoU), or the like).

In some embodiments, lookup table module 310 (re-)generates the one or more lookup table(s) 342 based on the changes to the one or more performance metric(s) 265 when (re-)training module 325 (re-)trains non-quantized network 261, quantized network 264, or the like. In some embodiments, lookup table module 310 (re-)generates the one or more lookup table(s) 342 based on the changes to the one or more performance metric(s) 265 when the one or more quantization scheme(s) 242 are iteratively (re-)selected for each layer, for each channel, for each parameter, for each kernel, or the like of non-quantized network 261, quantized network 264, or the like. In some embodiments, lookup table module 310 (re-)generates the one or more lookup table(s) 342 based on the changes to the one or more performance metric(s) 265 when (re-)training module 325 uses quantization coefficient module 220 to update, for each (re-)training iteration, the one or more quantization coefficient(s) 243 used to generate quantized feature(s) 263. In some embodiments, lookup table module 310 (re-)generates the one or more lookup table(s) 342 based on the changes to the one or more performance metric(s) 265 when the one or more quantization coefficient(s) 243 are iteratively updated based on the one or more performance metric(s) 265, the loss function, or the like.

Decision tree module 320 generates one or more decision tree(s) 341 associated with non-quantized network 261, quantized network 264, or the like. In some embodiments, decision tree module 320 generates one or more decision tree(s) 341 based on one or more decision tree algorithms such as C4.5 algorithm, ID3 (iterative dichotomiser 3) algorithm, C5.0 algorithm, gradient boosted trees, or the like. In some embodiments, decision tree module 320 generates one or more decision rules associated with one or more nodes, leaves, or the like of the one or more decision tree(s) 341. In some embodiments, decision tree module 320 generates one or more intermediate decisions associated with one or more nodes, leaves, or the like of the one or more decision tree(s) 341. In some embodiments, decision tree module 320 (re-)trains on non-quantized network 261, quantized network 264, or the like with tree supervision loss or the like.

In some embodiments, decision tree module 320 (re-)generates the one or more decision tree(s) 341 based on the changes to the one or more performance metric(s) 265 associated with non-quantized network 261, quantized network 264, or the like during (re-)training, inference, or the like. In some embodiments, decision tree module 320 (re-)generates, for each (re-)training iteration, the one or more decision tree(s) 341 based on the changes to the one or more performance metric(s) 265 (e.g., network accuracy, computational efficiency, quantization error, mean average precision, mean average recall mean absolute error (MAE), root mean squared error (RMSE), receiver operating characteristics (ROC), F1-score, area under the curve (AUC), area under the receiver operating characteristics (AUROC), mean squared error (MSE), statistical correlation, mean reciprocal rank (MRR), peak signal-to-noise ratio (PSNR), inception score, structural similarity (SSIM) index, frechet inception distance, perplexity, intersection over union (IoU), or the like).

In some embodiments, decision tree module 320 (re-)generates the one or more decision tree(s) 341 based on the changes to the one or more performance metric(s) 265 when (re-)training module 325 (re-)generates quantized feature(s) 263 based on iteratively selecting the one or more quantization scheme(s) 242, the one or more quantization coefficient(s) 243, the one or more performance metric(s) 265, the loss function, or the like. In some embodiments, decision tree module 320 (re-)generates the one or more decision tree(s) 341 based on the changes to the one or more performance metric(s) 265 when the one or more quantization scheme(s) 242 are iteratively (re-)selected for each layer, for each channel, for each parameter, for each kernel, or the like of non-quantized network 261, quantized network 264, or the like. In some embodiments, decision tree module 320 (re-)generates the one or more decision tree(s) 341 based on the changes to the one or more performance metric(s) 265 when (re-)training module 325 uses quantization coefficient module 220 to update, for each (re-)training iteration, the one or more quantization coefficient(s) 243 used to generate quantized feature(s) 263. In some embodiments, decision tree module 320 (re-)generates the one or more decision tree(s) 341 based on the changes to the one or more performance metric(s) 265 when the one or more quantization coefficient(s) 243 are iteratively updated based on the one or more performance metric(s) 265, the loss function, or the like.

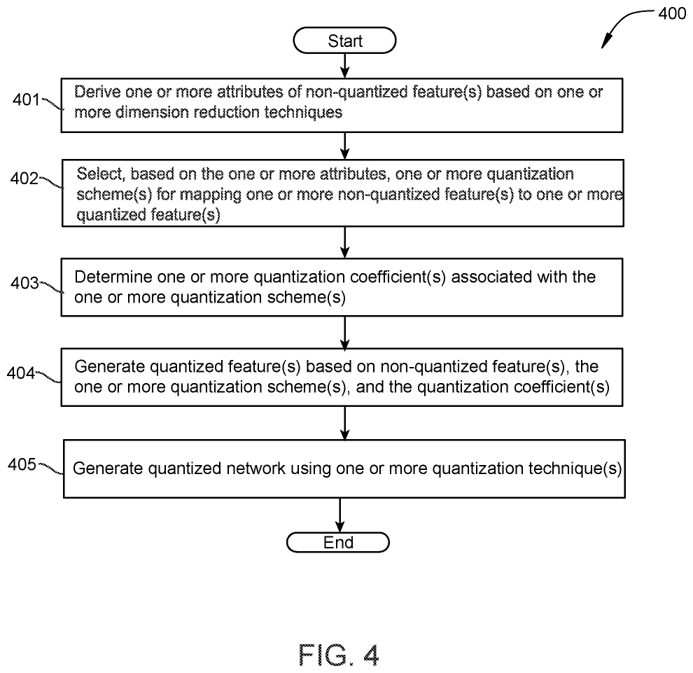

FIG. 4 is a flowchart of method steps 400 for a network quantization procedure performed by the quantization engine of FIG. 1, according to various embodiments of the present disclosure. Although the method steps are described in conjunction with the systems of FIGS. 1 and 2, persons skilled in the art will understand that any system configured to perform the method steps in any order falls within the scope of the present disclosure.

In step 401, quantization engine 122 uses quantization scheme module 210 to derive one or more attributes of non-quantized feature(s) 262 based on one or more dimension reduction techniques such as feature selection techniques (e.g., wrapper methods, filter methods, embedded methods, LASSO method, elastic net regularization, step-wise regression, or the like), feature projection techniques (e.g., principal component analysis (PCA), graph-based kernel PCA, non-negative matrix factorization (NMF), linear discriminant analysis (LDA), generalized discriminant analysis (GDA), or the like), k-nearest neighbors algorithms, or the like. In some embodiments, quantization engine 122 uses quantization scheme module 210 to derive one or more attributes based on one or more evaluation metrics (e.g., target quantization precision, model error rate, mutual information, pointwise mutual information, Pearson product-moment correlation coefficient, relief-based algorithms, inter/intra class distance, regression coefficients, or the like). In some embodiments, quantization engine 122 uses quantization scheme module 210 to determine one or more evaluation scores for each attribute subset based on the one or more evaluation metrics, one or more attribute or feature rankings, one or more attribute subsets, one or more redundant or irrelevant attributes, or the like. In some embodiments, quantization engine 122 uses quantization scheme module 210 to perform a pre-processing step to convert one or more attributes of non-quantized feature(s) 262 into an expected input range associated with the real-world range of raw-input values or the like.

In step 402, quantization engine 122 uses quantization scheme module 210 to select, based on the one or more attributes, one or more quantization scheme(s) 242 for mapping one or more non-quantized feature(s) 262 to one or more quantized feature(s) 263. In some embodiments, quantization engine 122 uses quantization scheme module 210 to select the quantization scheme(s) 242 based on one or more feature vectors associated with non-quantized features 262, a subset of relevant attributes associated with non-quantized features 262, the distribution of one or more attributes of non-quantized features 262, the distribution of one or more attributes of quantized features 263, divergence between the distribution of one or more attributes of non-quantized features 262 and the distribution of one or more attributes of quantized features 263, minimum or maximum values of non-quantized features 262, minimum or maximum values of quantized features 263, moving average of minimum or maximum values across one or more batches of non-quantized features 262, moving average of minimum or maximum values across one or more batches of quantized features 263, or the like. In some embodiments, quantization engine 122 uses quantization scheme module 210 to select a different quantization scheme(s) 242 for each layer, for each channel, for each parameter, for each kernel, or the like of non-quantized network 261 or the like. In some embodiments, quantization engine 122 uses quantization scheme module 210 to select one or more quantization scheme(s) 242 based on the target characteristics of the network output (e.g., range of values, maximum value, offset, minimum value, mean values, standard deviation, or the like).

In step 403, quantization engine 122 uses quantization coefficient module 220 to determine one or more quantization coefficient(s) 243 associated with the one or more quantization scheme(s) 242. In some embodiments, quantization engine 122 uses quantization coefficient module 220 to determine one or more quantization coefficient(s) 243 based on one or more evaluation metrics associated with one or more quantization scheme(s) 242 (e.g., target quantization precision, model error rate, mutual information, pointwise mutual information, Pearson product-moment correlation coefficient, relief-based algorithms, inter/intra class distance, regression coefficients, or the like). In some embodiments, quantization engine 122 uses quantization coefficient module 220 to apply a unique quantization coefficient(s) 243 to each unique attribute of non-quantized features 262 or the like.

In step 404, quantization engine 122 uses network quantization module 230 to generate quantized feature(s) 263 based on non-quantized feature(s) 262, the one or more quantization scheme(s) 242, and/or the quantization coefficient(s) 243. In some embodiments, quantization engine 122 uses quantization scheme module 210 to adaptively select, for each (re-)training iteration, the one or more quantization scheme(s) 242 used to generate quantized feature(s) 263. In some embodiments, the one or more quantization scheme(s) 242 used to generate quantized feature(s) 263 can be iteratively (re-)selected based on one or more performance metric(s) 265, a loss function, or the like. In some embodiments, the one or more quantization scheme(s) 242 can be iteratively (re-)selected for each layer, for each channel, for each parameter, for each kernel, or the like of non-quantized network 261, quantized network 264, or the like. In some embodiments, quantization engine 122 uses quantization coefficient module 220 to update, for each (re-)training iteration, the one or more quantization coefficient(s) 243 used to generate quantized feature(s) 263. The one or more quantization coefficient(s) 243 can be iteratively updated based on the one or more performance metric(s) 265, the loss function, or the like. In some embodiments, the one or more quantization coefficient(s) 243 can be iteratively updated for each layer, for each channel, for each parameter, for each kernel, or the like of non-quantized network 261, quantized network 264, or the like. In some embodiments, quantization engine 122 uses network quantization module 230 to iteratively (re-)generate quantized feature(s) 263 for each (re-)training iteration based on iteratively selecting the one or more quantization scheme(s) 242, the one or more quantization coefficient(s) 243, the one or more performance metric(s) 265, the loss function, or the like.

In step 405, quantization engine 122 uses network quantization module 230 to generate quantized network 264 using one or more quantization techniques (e.g., trained quantization, fixed quantization, soft-weight sharing, or the like). In some embodiments, network quantization module 230 generates quantized network 264 by (re-)training non-quantized network 261 using non-quantized features 262 or the like. In some embodiments, network quantization module 230 performs iterative quantization by (re-)training non-quantized network 261, quantized network 264, or the like using non-quantized features 262 until one or more performance metric(s) 265 are achieved. In some embodiments, network quantization module 230 (re-)trains non-quantized network 261, quantized network 264, or the like by simulating the effects of quantization during inference.

In some embodiments, network quantization module 230 updates the network parameters associated with non-quantized network 261, quantized network 264, or the like based on one or more performance metric(s) 265, a loss function, or the like. In some embodiments, network quantization module 230 updates the network parameters for multiple iterations until a threshold condition is achieved (e.g., a predetermined value or range for one or more performance metric(s) 265, a certain number of iterations of the (re-)training process, a predetermined amount of time, or the like). In some embodiments, the threshold condition is achieved when the (re-)training process reaches convergence (e.g., when one or more performance metric(s) 265 changes very little or not at all with each iteration of the (re-)training process, when one or more performance metric(s) 265, the loss function, or the like stays constant after a certain number of iterations). In some embodiment, network quantization module 230 (re-)trains non-quantized network 261, quantized network 264, or the like using one or more hyperparameters (e.g., a learning rate, a convergence parameter that controls the rate of convergence in a machine learning model, a model topology, a number of training samples in training data for a machine learning model, a parameter-optimization technique, a data-augmentation parameter that applies transformations to inputs, a model type, or the like).

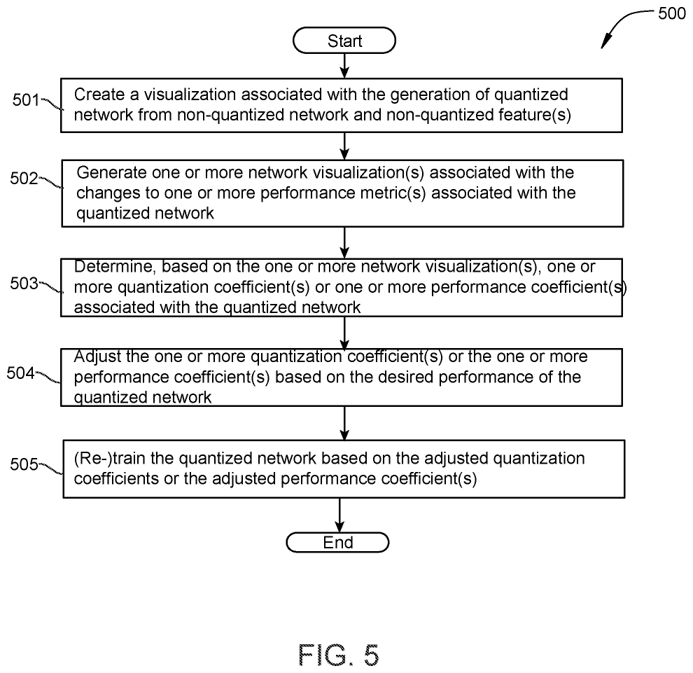

FIG. 5 is a flowchart of method steps 500 for a network visualization procedure performed by the visualization engine of FIG. 1, according to various embodiments of the present disclosure. Although the method steps are described in conjunction with the systems of FIGS. 1 and 3, persons skilled in the art will understand that any system configured to perform the method steps in any order falls within the scope of the present disclosure.

In step 501, visualization engine 124 uses (re-)training module 325 to create a visualization associated with the generation of quantized network 264 from non-quantized network 261 and non-quantized feature(s) 262. In some embodiments, visualization engine 124 uses (re-)training module 325 to create a visualization associated with the generation of quantized network 264 using one or more quantization techniques (e.g., trained quantization, fixed quantization, soft-weight sharing, or the like).

In step 502, visualization engine 124 uses visualization module 330 to generate one or more network visualization(s) 343 associated with the changes to one or more performance metric(s) 265 associated with quantized network 264 or the like. In some embodiments, visualization engine 124 uses visualization module 330 to (re-)generate one or more network visualization(s) 343 of the relative changes in the one or more performance metric(s) 265 for each layer, for each channel, for each parameter, for each kernel, or the like. In some embodiments, visualization engine 124 uses visualization module 330 to (re-)generate, for each (re-)training iteration, one or more network visualization(s) 343 showing changes to the one or more performance metric(s) 265 or the like.

In some embodiments, visualization engine 124 uses visualization module 330 to (re-)generate one or more network visualization(s) 343 of the relative changes in the one or more performance metric(s) 265 when (re-)training module 325 (re-)generates quantized feature(s) 263 based on iteratively selecting the one or more quantization scheme(s) 242, the one or more quantization coefficient(s) 243, the one or more performance metric(s) 265, the loss function, or the like. In some embodiments, visualization engine 124 uses visualization module 330 to (re-)generate one or more network visualization(s) 343 when the one or more quantization scheme(s) 242 are iteratively (re-)selected for each layer, for each channel, for each parameter, for each kernel, or the like of non-quantized network 261, quantized network 264, or the like. In some embodiments, visualization engine 124 uses visualization module 330 to (re-)generate one or more network visualization(s) 343 when (re-)training module 325 iteratively updates, for each (re-)training iteration, the one or more quantization coefficient(s) 243 based on the one or more performance metric(s) 265, the loss function, or the like.

In step 503, visualization engine 124 uses visualization module 330 to determine, based on the one or more network visualization(s) 343, one or more quantization coefficient(s) 243, one or more performance coefficient(s) 344, or the like associated with quantized network 264 or the like. In some embodiments, visualization engine 124 uses visualization module 330 to calculate one or more quantization coefficient(s) 243, one or more performance coefficient(s) 344, or the like based on one or more actual statistical properties (e.g., actual mean values, actual minimum or maximum values, actual standard deviation, actual range of values, actual median values, and/or the like) associated with the one or more performance metric(s) 265. In some embodiments, visualization engine 124 uses visualization module 330 to determine the one or more quantization coefficient(s) 243, one or more performance coefficient(s) 344, or the like based on one or more statistical properties associated with non-quantized network 261, non-quantized features 262, quantized features 263, quantized network 264, quantization data 240, or the like.

In step 504, visualization engine 124 uses visualization module 330 to adjust the one or more quantization coefficient(s) 243, one or more performance coefficient(s) 344, or the like based on the target performance of quantized network 264 or the like. In some embodiments, visualization engine 124 uses visualization module 330 to adjust one or more target statistical properties (e.g., target mean values, target minimum or maximum values, target standard deviation, target range of values, target median values, and/or the like) associated with the one or more quantization coefficient(s) 243, one or more performance coefficient(s) 344, or the like. In some embodiments, visualization engine 124 uses visualization module 330 to adjust the one or more quantization coefficient(s) 243, one or more performance coefficient(s) 344, or the like by changing one or more target statistical properties associated with one or more performance metric(s) 265, non-quantized network 261, non-quantized features 262, quantized features 263, quantized network 264, quantization data 240, or the like.

In step 505, visualization engine 124 uses (re-)training module 325 to (re-)train quantized network 264 or the like based on the adjusted performance coefficient(s) 344. The (re-)training is performed in a manner similar to that disclosed above with respect to network quantization module 230. For instance, visualization engine 124 uses (re-)training module 325 to update the network parameters associated with non-quantized network 261, quantized network 264, or the like at each (re-)training iteration based on the adjusted performance coefficient(s) 344. In some embodiments, visualization engine 124 uses (re-)training module 325 to repeat the (re-)training process for multiple iterations until a threshold condition is achieved (e.g., a predetermined value or range for one or more quantization coefficient(s) 243, one or more performance coefficient(s) 344, or the like, a certain number of iterations of the (re-)training process, a predetermined amount of time, or the like). In some embodiments, the threshold condition is achieved when the (re-)training process reaches convergence (e.g., when one or more quantization coefficient(s) 243, one or more performance coefficient(s) 344, or the like changes very little or not at all with each iteration of the (re-)training process, when one or more quantization coefficient(s) 243, one or more performance coefficient(s) 344, or the like stays constant after a certain number of iterations, or the like). In some embodiment, visualization engine 124 uses (re-)training module 325 to (re-)train non-quantized network 261, quantized network 264, or the like using one or more hyperparameters (e.g., a learning rate, a convergence parameter that controls the rate of convergence in a machine learning model, a model topology, a number of training samples in training data for a machine learning model, a parameter-optimization technique, a data-augmentation parameter that applies transformations to inputs, a model type, or the like).

In sum, quantization scheme module 210 adaptively derives one or more attributes associated with non-quantized features 262 using one or more dimension reduction techniques. Quantization scheme module 210 then selects, based on the one or more attributes, one or more quantization scheme(s) 242 for mapping one or more non-quantized features 262 to one or more quantized features 263. Quantization coefficient module 220 determines one or more quantization coefficient(s) 243 associated with the one or more quantization scheme(s) 242 selected by quantization scheme module 210. Network quantization module 230 generates quantized feature(s) 263 based on non-quantized feature(s) 262, the one or more quantization scheme(s) 242, and the quantization coefficient(s) 243. Network quantization module 230 generates quantized network 264 using one or more quantization techniques.

Visualization module 330 generates one or more network visualization(s) 343 associated with the changes to the one or more performance metric(s) 265 associated with non-quantized network 261, quantized network 264, or the like during (re-)training, inference, or the like. Visualization module 330 determines, based on the one or more network visualization(s) 343, one or more quantization coefficient(s) 243, one or more performance coefficient(s) 344, or the like. Visualization module 330 adjusts the one or more quantization coefficient(s) 243, the one or more performance coefficient(s) 344, or the like based on the target performance of non-quantized network 261, quantized network 264, or the like. Visualization module 330 then uses (re-)training module 325 to (re-)train non-quantized network 261, quantized network 264, or the like based on the adjusted quantization coefficients, the adjusted performance coefficients, or the like.

The disclosed techniques achieve various advantages over prior-art techniques. In particular, by adapting the quantization scheme used to generate quantized inputs, disclosed techniques allow for generation of smaller, faster, more robust, and more generalizable quantized neural networks that can be applied to a wider range of applications. In addition, disclosed techniques provide users with a way to visualize the performance of quantized neural networks relative to non-quantized neural, thereby allowing users develop an intuitive understanding of the decisions and rationale applied by the quantized neural network and to better interpret changes in factors that correlate with the performance of the quantized neural network (e.g., changes in patterns of connections between neurons, areas of interest, weights, activations, or the like). As such, users are able to determine what parameters to adjust in order to fine-tune and improve the performance of the quantized neural network.

1. In some embodiments, a computer-implemented method for adaptive visualization of a quantized neural network comprises: generating one or more network visualizations of a neural network; determining, based on the one or more network visualizations, one or more quantization schemes associated with the neural network; and re-training the neural network or approximating the neural network, based on adjusting one or more quantization coefficients associated with the one or more quantization schemes

2. The computer-implemented method of clause 1, wherein the one or more network visualizations are associated with one or more changes to one or more performance metrics.

3. The computer-implemented method of clauses 1 or 2, wherein the one or more network visualizations are associated with one or more inputs of the neural network, one or more parameters of the neural network, one or more inner layer outputs of the neural network, or one or more performance metrics of the neural network.

4. The computer-implemented method of clauses 1-3, wherein the one or more network visualizations are iteratively updated based on the one or more quantization coefficients.

5. The computer-implemented method of clauses 1-4, wherein the one or more performance coefficients are based on one or more actual statistical properties associated with the one or more quantized input features.

6. The computer-implemented method of clauses 1-5, wherein the one or more performance coefficients are adjusted based on one or more target characteristics of an output of the neural network.

7. The computer-implemented method of clauses 1-6, further comprising: replacing the neural network with one or more decision trees during inference.

8. The computer-implemented method of clauses 1-7, further comprising: replacing the neural network with one or more lookup tables during inference.

9. The computer-implemented method of clauses 1-8, further comprising: determining, based on the one or more performance coefficients, whether a threshold condition is achieved, and updating, based on the one or more performance coefficients, one or more parameters of the neural network.

10. In some embodiments, one or more non-transitory computer readable media store instructions that, when executed by one or more processors, cause the one or more processors to perform the steps of: generating one or more network visualizations of a neural network; determining, based on the one or more network visualizations, one or more quantization schemes associated with the neural network; and re-training the neural network or approximating the neural network, based on adjusting one or more quantization coefficients associated with the one or more quantization schemes.

11. The one or more non-transitory computer readable media of clause 10, wherein the one or more network visualizations are associated with one or more changes to one or more performance metrics.

12. The one or more non-transitory computer readable media of clauses 10 or 11, wherein the one or more network visualizations are associated with one or more inputs of the neural network, one or more parameters of the neural network, or one or more inner layer outputs of the neural network.

13. The one or more non-transitory computer readable media of clauses 10-12, wherein the one or more network visualizations are iteratively updated based on the one or more quantization coefficients.

14. The one or more non-transitory computer readable media of clauses 10-13, wherein the one or more performance coefficients are based on one or more actual statistical properties associated with the one or more quantized input features.

15. The one or more non-transitory computer readable media of clauses 10-14, wherein the one or more performance coefficients are adjusted based on one or more target characteristics of an output of the neural network.

16. The one or more non-transitory computer readable media of clauses 10-15, further comprising: replacing the neural network with one or more decision trees during inference.

17. The one or more non-transitory computer readable media of clauses 10-16, further comprising: replacing the neural network with one or more lookup tables during inference.

18. The one or more non-transitory computer readable media of clauses 10-17, further comprising: determining, based on the one or more performance coefficients, whether a threshold condition is achieved, and updating, based on the one or more performance coefficients, one or more parameters of the neural network.

19. In some embodiments, a system comprises: a memory storing one or more software applications; and a processor that, when executing the one or more software applications, is configured to perform the steps of: generating one or more network visualizations of a neural network; determining, based on the one or more network visualizations, one or more quantization schemes associated with the neural network; and re-training the neural network or approximating the neural network, based on adjusting one or more quantization coefficients associated with the one or more quantization schemes.

20. The system of clause 19, wherein the one or more network visualizations are associated with one or more changes to one or more performance metrics.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, computational graphs, binary format representations, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for adaptive visualization of a quantized neural network, the method comprising:
generating one or more network visualizations of a neural network;
determining, based on the one or more network visualizations, one or more quantization schemes associated with the neural network; and
re-training the neural network or approximating the neural network, based on adjusting one or more quantization coefficients associated with the one or more quantization schemes.

2. The computer-implemented method of claim 1, wherein the one or more network visualizations are associated with one or more changes to one or more performance metrics.

3. The computer-implemented method of claim 1, wherein the one or more network visualizations are associated with one or more inputs of the neural network, one or more parameters of the neural network, one or more inner layer outputs of the neural network, or one or more performance metrics of the neural network.

4. The computer-implemented method of claim 1, wherein the one or more network visualizations are iteratively updated based on the one or more quantization coefficients.

5. The computer-implemented method of claim 1, wherein the one or more performance coefficients are based on one or more actual statistical properties associated with the one or more quantized input features.

6. The computer-implemented method of claim 1, wherein the one or more performance coefficients are adjusted based on one or more target characteristics of an output of the neural network.

7. The computer-implemented method of claim 1, further comprising:
replacing the neural network with one or more decision trees during inference.

8. The computer-implemented method of claim 1, further comprising:
replacing the neural network with one or more lookup tables during inference.

9. The computer-implemented method of claim 1, further comprising:
determining, based on the one or more performance coefficients, whether a threshold condition is achieved, and
updating, based on the one or more performance coefficients, one or more parameters of the neural network.

10. One or more non-transitory computer readable media storing instructions that, when executed by one or more processors, cause the one or more processors to perform the steps of:
generating one or more network visualizations of a neural network;
determining, based on the one or more network visualizations, one or more quantization schemes associated with the neural network; and
re-training the neural network or approximating the neural network, based on adjusting one or more quantization coefficients associated with the one or more quantization schemes.

11. The one or more non-transitory computer readable media of claim 10, wherein the one or more network visualizations are associated with one or more changes to one or more performance metrics.

12. The one or more non-transitory computer readable media of claim 10, wherein the one or more network visualizations are associated with one or more inputs of the neural network, one or more parameters of the neural network, one or more inner layer outputs of the neural network, or one or more performance metrics of the neural network.

13. The one or more non-transitory computer readable media of claim 10, wherein the one or more network visualizations are iteratively updated based on the one or more quantization coefficients.

14. The one or more non-transitory computer readable media of claim 10, wherein the one or more performance coefficients are based on one or more actual statistical properties associated with the one or more quantized input features.

15. The one or more non-transitory computer readable media of claim 10, wherein the one or more performance coefficients are adjusted based on one or more target characteristics of an output of the neural network.

16. The one or more non-transitory computer readable media of claim 10, further comprising:
replacing the neural network with one or more decision trees during inference.

17. The one or more non-transitory computer readable media of claim 10, further comprising:
replacing the neural network with one or more lookup tables during inference.

18. The one or more non-transitory computer readable media of claim 10, further comprising:
determining, based on the one or more performance coefficients, whether a threshold condition is achieved, and
updating, based on the one or more performance coefficients, one or more parameters of the neural network.

19. A system, comprising:
a memory storing one or more software applications; and
a processor that, when executing the one or more software applications, is configured to perform the steps of:
generating one or more network visualizations of a neural network;
determining, based on the one or more network visualizations, one or more quantization schemes associated with the neural network; and
re-training the neural network or approximating the neural network, based on adjusting one or more quantization coefficients associated with the one or more quantization schemes.

20. The system of claim 19, wherein the one or more network visualizations are associated with one or more changes to one or more performance metrics.
